(19) United States
(12) Patent Application Publication
(10) Pub. No.: US 2017/0321060 A1
(43) Pub. Date: Nov. 9, 2017

(54) ANTIFOG COATING COMPOSITION

(71) Applicant: MOMENTIVE PERFORMANCE MATERIALS INC., Waterford, NY (US)

(72) Inventors: Laxmi Samantara, Bangalore (IN); Indumathi Ramakrishnan, Bangalore (IN); Andreas Haeuseler, Cologne (DE)

(21) Appl. No.: 15/148,654

(22) Filed: May 6, 2016

(51) Int. Cl. C09D 5/00; C08J 7/18; C09D 7/12; C09D 4/00; C08K 9/06

(52) U.S. Cl. CPC C09D 5/00; C09D 7/1225; C09D 4/00; C08J 7/18; C08J 2369/00; C08J 2433/14; C08K 9/06; C08J 2435/02

(57) ABSTRACT

A curable composition includes (i) an acrylic functional silicone material; (ii) an acrylic functional organic material; (iii) an acrylic functional urethane material; and optionally (iv) metal oxide particles. Upon curing, the compositions provide a coating that may exhibit good optical clarity, adhesion to various plastics, and good antifog performance.

### FIELD

The present technology relates to an antifog coating composition, methods of making an antifog coating composition, and articles comprising antifog coatings formed from such compositions. In particular, the present technology relates to an antifog coating composition comprising a combination of acrylic functional materials including an acrylic functional silicone. The antifog coating compositions may be applied to a substrate, such as a plastic substrate, to coat the substrate. The coatings exhibit good properties including, for example, adhesion, optical clarity, and excellent antifog properties.

### BACKGROUND

Plastic substrates, such as polycarbonate, are commonly used in automotive applications because of their high transparency, heat resistance, and impact resistance. Plastic materials, when used under conditions above or below ambient conditions of temperature and humidity (25° C., 50% RH) or under conditions with a large difference in temperature and/or in humidity, may fog and lose their transparency from dew on the surface of the plastic. The design in head lamps has recently changed from halogen to LED lamps. These new LED lamp designs appear to have a higher likelihood of fogging, which can affect the visibility. Also, in tropical or wet climates, the LED lamps may fog and visibility can be adversely affected.

Different types of coating materials are available as antifog coatings. Most of the coatings have some hydrophilic groups in the coating composition, which provide antifog performance. Hydrophilic groups, however, absorb moisture from ambient and leave hazy spots on the coating surface. It is often difficult to wipe off moisture from the surface because of the intricate structure of the coated articles. Therefore, coating appearance and clarity can be significantly affected. Also, water can get absorbed in the coating structure over time, which may cause permanent damage to the coating and substrate. Hence, there is a need to improve the optical quality and appearance of the coating for longer periods of time while maintaining antifog properties of the coating without water/moisture being absorbed in the coating.

There are different ways a conventional antifog coating can be obtained. Surfactants are often used to provide antifog performance of a coating. Polyalkylene glycols, hydrophilic polymers such as poly acrylic acid, poly vinyl pyrolidone, poly vinyl alcohols, ionic polymers, metal oxides, and silanes are also used for antifog coating. U.S. Publication No. 2012/0245250 describes a copolymer formed from a monomer mixture of N-methylol meth acrylamide and sulfopropyl methacrylate in combination with a surfactant that can be used for antifog applications. U.S. Pat. No. 8,039,047 describes the use of nanoparticles such as SiO₂ with hydrophilic side chains for antifog coatings. U.S. Publication No. 2012/0045650 describes the use of organosiloxane for antifog coatings. Chinese Publication 10390455 describes the use of acrylates in coating composition for antifog applications. EP 2 657 293 describes compositions with water absorbing monomers such as different acrylamides for UV curable antifog coatings. U.S. Pat. No. 7,601,768 describes an antifog coating composition for forming an antifog coating without running water trace.

Silicone based materials can provide improved hydrophobicity, water repellency and better wettability when they are used in antifog compositions. Using significant concentrations of silicone based materials presents a challenge in antifog compositions because they do not cure fully in UV and also do not provide adhesion to plastic substrates.

### SUMMARY

The present invention provides a curable composition that contains an appropriate amount of functional silicone that provides desirable antifog performance while maintaining sufficient optical clarity and long term adhesion to plastic substrates.

In one aspect, the present invention provides a curable coating composition comprising (i) at least one acrylic functional silicone material; (ii) at least one acrylic functional organic material; and (iii) at least one acrylic functional urethane material.

In one embodiment, the acrylic functional silicone material (i) is chosen from a silicone polyether acrylate, a silicone dimethacrylate, a silicone acrylamide, or a combination of two or more thereof.

In one embodiment of the curable coating composition according to any previous embodiment, the acrylic functional silicone material (i) is chosen from a compound of the formula:

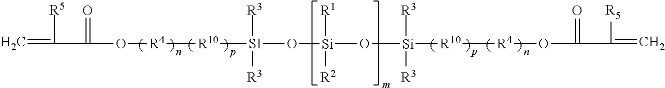

wherein R¹ and R² are independently chosen from a C1-C10 alkyl group, a C6-30 aryl group or R⁴; wherein each occurrence of R³ is independently chosen from a C1-C10 alkyl group or a C6-C30 aryl group; wherein each occurrence of R⁴ is independently a linear or a branched alkylene chain of 1 to 10 carbon atoms optionally substituted with at least one heteroatom chosen from O, N or S; wherein each occurrence of R⁵ is independently chosen from hydrogen or a C1-C6 alkyl group; R¹⁰ is polyether unit; m an integer ≧0; n is an integer from 1 to 100, and p is an integer from 0 to 100.

In one embodiment of the curable coating composition according to any previous embodiment, the acrylic functional silicone material (i) is present in an amount of from about 2 wt. % to about 60 wt. % based on the weight of a dry film formed from the composition.

In one embodiment of the curable coating composition according to any previous embodiment, the acrylic functional organic material (ii) is chosen from a compound of the formula:

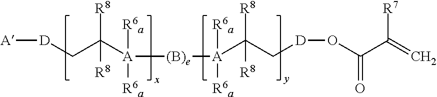

wherein

R⁶ is independently selected from the group consisting of: O; H; a linear alkyl group containing from 1 to 5 carbon atoms; a linear alkyl group containing from 1 to 5 carbon atoms substituted with a hydroxy or an alkoxy group; an aromatic group; a hydroxy group; an alkoxy group containing from 1 to 3 carbon atoms; a methacrylate; and an acrylate group; wherein a is 0 or 1;

R⁷ is independently chosen from H or CH₃;

R⁸ is independently selected from the group consisting of H, an alkyl group having from 1 to 6 carbon atoms, a hydroxy group, an alkoxy group having from 1 to 3 carbon atoms, a methacrylate group, and an acrylate group;

A is independently selected from the group consisting of O, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, an alkylene oxide, and a substituted or unsubstituted divalent heterocyclic group having from 5 to 20 carbon atoms;

A′ is independently selected from H, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, a substituted or unsubstituted divalent heterocyclic group having from 5 to 20 carbon atoms, a methacrylate group, and an acrylate group;

B is independently selected from O, an NH moiety, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, a substituted or unsubstituted divalent heterocyclic group having from 5 to 20 carbon atoms, and a bisphenol A unit; wherein e is an integer from 0 to 1;

D is independently selected from null, direct bond, a substituted or unsubstituted linear alkyl group having from 1 to 20 carbon atoms, isopropanol, epoxy ring opened unit, a substituted or unsubstituted divalent aromatic group having from 6 to 20 carbon atoms, a substituted or unsubstituted divalent heterocyclic group having from 5 to 20 carbon atoms; and

y is an integer from 1 to 50 and x is an integer from 0 to 50.

In one embodiment of the curable coating composition according to any previous embodiment, the acrylic functional organic material (ii) is chosen from a poly(ethyleneoxy)methacrylate, a poly(ethyleneoxy)acrylate, a poly(ethyleneoxy)monomethylether acrylate, a poly(ethyleneoxy)monomethylether methacrylate, a pentaerythritol triacrylate, a glycerol dimethacrylate, a glycerol diacrylate, a bisphenol-A-glycerol tetraacrylate, a bisphenol-A-glycerol diacrylate, a bisphenol-A-ethyleneoxy diacrylate, or a combination of two or more thereof.

In one embodiment of the curable coating composition according to any previous embodiment, the acrylic functional organic material (ii) is chosen from Isooctyl Acrylate; 2-2(Ethoxyethoxy)ethyl Acrylate; Isodecyl Acrylate; Isodecyl Methacrylate; Lauryl Acrylate; Lauryl Methacrylate; Isodecyl Acrylate; Propoxylated Neopentyl Glycol Diacrylate; Alkoxylated Difunctional Acrylate Ester; Glycidyl Methacrylate; Propoxylated Neopentyl Glycol Diacrylate; Alkoxylated Difunctional Acrylate Ester; Tridecyl Methacrylate; Tridecyl Acrylate; Caprolactone Acrylate; Tripropylene Glycol Diacrylate; Stearyl Methacrylate; Tris (2-Hydroxy Ethyl) isocyanurate Triacrylate; 1,3-Butylene Glycol Dimethacrylate; 1,3-Butylene Glycol Diacrylate; Neopentyl Glycol Diacrylate; Neopentyl Glycol Dimethacrylate; Ethylene Glycol Dimethacrylate; Alkoxylated Aliphatic Diacrylate Ester; 1,4-Butanediol Diacrylate; 1,4-Butanediol Dimethacrylate; C14-C15 Acrylate Terminated Monomer; Tetrahydrofurfuryl Methacrylate; Hexanediol Diacrylate; 1,6-Hexanediol Dimethacrylate; 1,6-Hexanediol Diacrylate; Tetrahydrofurfuryl Acrylate; Hexanediol Dimethacrylate; Propoxylated Trimethylolpropane Triacrylate; Cyclohexyl Acrylate; Highly Propoxylated Glyceryl Triacrylate; Tetrahydrofurfuryl Acrylate; Cyclohexyl Methacrylate; Triethylene Glycol Dimethacrylate; C14-C15 Methacrylate Terminated Monomer; Tetraethylene Glycol Dimethacrylate; Propoxylated₃ Trimethylolpropane Triacrylate; Diethylene Glycol Diacrylate; Polyethylene Glycol Dimethacrylate; Propoxylated Glyceryl Triacrylate; Triethylene Glycol Diacrylate; Diethylene Glycol Dimethacrylate; Highly Propoxylated Glyceryl Triacrylate; Tetraethylene Glycol Diacrylate; Caprolactone Acrylate; Polyethylene Glycol (200) Diacrylate; Polyethylene Glycol (400) Dimethacrylate; Di-trimethylolpropane Tetraacrylate; Polyethylene Glycol (600) Dimethacrylate; Polyethylene Glycol (400) Diacrylate; Polyethylene Glycol (600) Dimethacrylate; Polyethylene Glycol (600) Diacrylate; Ethoxylated Trimethylolpropane Triacrylate; Ethoxylated₃ Trimethyolopropane Triacrylate; Ethoxylated₆ Trimethylolpropane Triacrylate; Ethoxylated₉ Trimethylolpropane Triacrylate; Ethoxylated₁₅ Trimethylolpropane Triacrylate; Alkoxylated Trifunctional Acrylate Ester; Ethoxylated Trimethylolpropane Triacrylate; Ethoxylated₂₀ Trimethylolpropane Triacrylate; Trimethylolpropane Trimethacrylate; Ethoxylated Trimethylolpropane Triacrylate; Ethoxylated Pentaerythritol Triacrylate; Isobornyl Acrylate; Trimethylolpropane Triacrylate; Trifunctional Methacrylate Ester; Trifunctional Methacrylate Ester; Trifunctional Methacrylate Ester; Isobornyl Acrylate; Isobornyl Methacrylate; Isobornyl Methacrylate; Di-Trimethylolpropane Tetraacrylate; Pentaerythritol Triacrylate; Aliphatic Urethane Acrylate; Low Viscosity Aliphatic Diacrylate; Pentaerythritol Tetraacrylate; Dipentaerythritol Pentaacrylate; Low Viscosity Aliphatic Triacrylate Oligomer; Dimethacrylate Aliphatic Urethane Acrylate; Ethoxylated Nonylphenol Acrylate; Phenoxyethyl Methacrylate; 2-Phenoxyethyl Methacrylate; Ethoxylated₁₀ Bisphenol A Diacrylate; Phenoxyethyl Acrylate; 2-Phenoxyethyl Acrylate; Ethoxylated₆ Bisphenol A Dimethacrylate; Ethoxylated₄ Bisphenol A Dimethacrylate; Ethoxylated₄ Bisphenol A Diacrylate; Ethoxylated Bisphenol A Dimethacrylate; Ethoxylated₂ Bisphenol A Dimethacrylate; Ethoxylated Bisphenol A Diacrylate, or a combination of two or more thereof.

In one embodiment of the curable coating composition according to any previous embodiment, the acrylic functional organic material (ii) is present in an amount of from about 1 wt. % to about 80 wt. % based on the weight of a dry film formed from the composition.

In one embodiment of the curable coating composition according to any previous embodiment, the acrylic functional urethane (iii) comprises two or more acrylate functional groups.

In one embodiment of the curable coating composition according to any previous embodiment, the acrylic functional urethane (iii) is chosen from an aliphatic polyester urethane acrylate, an aliphatic polyether urethane acrylate, an acrylated polyurethane dispersion, or a combination thereof.

In one embodiment of the curable coating composition according to any previous embodiment, the acrylic functional urethane (iii) is present in an amount of from about 5 wt. % to about 98 wt. % based on the weight of a dry film formed from the composition.

In one embodiment of the curable coating composition according to any previous embodiment, the composition further comprises metal oxide particles (iv) chosen from silica oxide particles, aluminum oxide particles, cerium oxide, titanium oxide, zinc oxide particles, tin oxide particles, or a combination of two or more thereof. In one embodiment, the metal oxide particles (iv) are functionalized with a silane and siloxane. In one embodiment, the metal oxide particles (iv) are present in an amount of from about 0.1 to about 40 wt. % based on the weight of a dry film formed from the composition.

In one embodiment of the curable coating composition according to any previous embodiment, the composition further comprises a photoinitiator, thermal initiator, surface active agent, cure promoters and mixtures thereof.

In one embodiment of the curable coating composition according to any previous embodiment, the composition further comprises at least one surfactant chosen from an ionic surfactant, a non-ionic surfactant, or a combination thereof.

In another aspect, the present invention provides an article comprising a substrate, wherein at least a portion of a surface of the substrate comprises a coating formed the curable composition according to any of the previous embodiments.

In one embodiment of the article, the substrate is chosen from an acrylic polymer, a polyamide, a polyacrylate, a polyimide, an acrylonitrile-styrene copolymer, a styrene-acrylonitrile-butadiene terpolymer, a polyvinyl chloride, a polyethylene, a polycarbonate, or a combination thereof. In one embodiment, the substrate comprises a polycarbonate.

In one embodiment of the article according to any previous embodiment, the coating has a transmittance of coating of at least 85%.

In one embodiment of the article according to any previous embodiment, the coating after curing has a transmittance of coating of at least 89%.

In one embodiment of the article according to any previous embodiment, the article is an automobile headlight, a windshield, eyeglasses, goggles, a mirror, a storage container, a window, or a camera lens.

In still another aspect, the present invention provides a method of forming an article coated with an antifog coating comprising:

applying the curable composition of any of the previous embodiments to a surface of a substrate; and

exposing the curable composition to actinic or electron beam radiation to cure the coating.

The following description and the drawings disclose various illustrative aspects. Some improvements and novel aspects may be expressly identified, while others may be apparent from the description and drawings.

### BRIEF DESCRIPTION OF THE DRAWINGS

FIG. 1(a) is a graph comparing the haze before and after antifog testing for embodiments of the present invention;

FIG. 1(b) is a graph comparing the haze before and after storage of the coating for embodiments of the present invention; and

FIG. 2 is graph comparing the gloss of coatings of the present invention to that of polycarbonate for three different gloss angles: 20°, 60°, and 85°

### DETAILED DESCRIPTION

The present invention provides a curable composition comprising a silicone based material that is useful as a coating on a variety of substrates. Coatings formed from the curable composition may exhibit one or more properties that include good adhesion (5B as per ASTM D3200/D3359), high gloss (ASTM D2457), high transmittance (>85%), and low haze (<1) as per ASTM D1003, and/or antifog properties.

In one aspect, the present invention provides a curable composition comprising (i) an acrylic functional silicone material; (ii) an acrylic functional organic material; and (iii) an acrylic functional urethane material. The composition may optionally comprise (iv) metal oxide particles. The acrylic functionality of components (i), (ii), or (iii) is provided by an acrylate functional group or an (alkyl)acrylate group (e.g., a (meth)acrylate functional group, an (eth)acrylate functional group, etc.). As used herein the term “acrylate” encompasses both acrylate and (alkyl)acrylate functional groups. Additionally, the terms “acrylic functional” and “acrylate functional” may be used interchangeably to refer to a material that comprises an acrylate functionality.

The acrylic functional silicone material (i) comprises an organosiloxane comprising one or more acrylate functional groups. In embodiments, the acrylic functional silicone material comprises a plurality of acrylate functional groups. The acrylic functional organosiloxane may comprise the acrylate functional groups pendant to a silicone atom in the siloxane backbone. For example, the acrylate functional group may be connected to a silicon atom in the backbone via a linking group such as an alkylene oxide (e.g., ethylene oxide). The acrylate functionality may be attached to a silicon atom in one of the siloxane repeating units of the siloxane backbone. In other embodiments, the acrylate functional groups may be attached to a silicon atom at the terminal ends of the organosiloxane backbone.

In one embodiment, the acrylic functional organosiloxane comprises a siloxane that is end-capped or terminated with acrylic functional alkylsilyl or arylsilyl groups. The acrylate functional organosiloxane may have a viscosity of from about 10 mPas to about 20000 mPas; from about 50 mPas to about 4000 mPas; even from about 50 mPas to about 1000 mPas. Viscosity may be evaluated and measured in a Haake Rheostress 600 using a 60 mm parallel plate, with steady shear rate of 10 S⁻¹. Here as elsewhere in the specification and claims, numerical values may be combined to form new and non-disclosed ranges.

It will be appreciated that the curable composition may comprise two or more different acrylate functional organosiloxanes. The acrylate functional organosiloxanes may be different in terms of polymer size (as evidenced by viscosity), structure (e.g., different organic or acrylate groups), or both.

In one embodiment, the acrylic functional organosiloxane may be a siloxane of the formula:

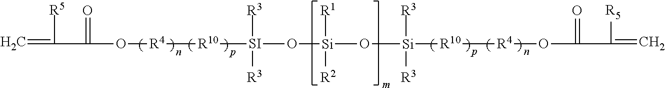

where R¹ and R² are independently chosen from a C1-C10 alkyl, a C6-30 aryl group or R⁴; each occurrence of R³ is independently chosen from a C1-C10 alkyl or a C6-C30 aryl; each occurrence of R⁴ is independently a linear or branched alkylene chain of 1 to 10 carbon atoms optionally substituted with heteroatom(s) that includes O, N and S; each occurrence of R⁵ is independently chosen from hydrogen or a C1-C6 alkyl; R¹° is a polyether unit; m is an integer ≧0; n is an integer selected from 1 to 100, preferably selected from 1 to 75 and more preferably selected from 1 to 50; p is an integer from 0 to 100.

In one embodiment, R¹, R², and R³ are each an alkyl group chosen from a C1-C10 alkyl, a C2-C8 alkyl, even a C4-C6 alkyl. In one embodiment, each occurrence of R¹, R², and R³ is methyl. In another embodiment, R⁴ is chosen from a C1-C10 oxyalkylene, a C1-C6 alkylene, a C2-C4 alkylene, or a C3 alkylene. In embodiments, R⁵ is H or methyl.

As described above, m is an integer ≧0. In one embodiment, m is from 0 to about 75; from about 5 to about 60; or from about 5 to about 50. As described above, p is 0 to 100. In one embodiment, p is about 1 to about 90; about 5 to about 75; or about 10 to about 50.

Examples of suitable acrylic functional silicone materials include, but are not limited to, those available from Momentive Performance Materials Inc. under the trade designations CoatOSil® 3503 and CoatOSil® 3509; and those available Evonik under the trade designations TEGO® Rad 2300 TEGO® Rad 2250, TEGO® Rad 2300, TEGO® Rad 2500, and TEGO® Rad 2700.

The acrylic functional silicone material (i) may be present in an amount of from about 2 wt. % to about 50 wt. % based on the weight of a dry film formed from the composition; from about 5 wt. % to about 40 wt. % based on the weight of a dry film formed from the composition; or from about 10 wt. % to about 25 wt. % based on the weight of a dry film formed from the composition.

The acrylic functional organic material (ii) may be chosen from an organic based compound comprising one or more acrylate functional groups. In one embodiment, the acrylic functional organic compound comprises two or more acrylate functional groups.

In embodiments, the acrylic functional organic material is a multi-functional acrylic material of the formula:

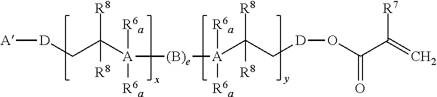

where R⁶ is independently selected from the group consisting of O; H; a linear alkyl group containing from 1 to 5 carbon atoms; a linear alkyl group containing from 1 to 5 carbon atoms substituted with a hydroxy or an alkoxy group; an aromatic group; a hydroxy group; an alkoxy group containing from 1 to 3 carbon atoms; a methacrylate, and an acrylate group; wherein a is an integer from 0 to 1;

R⁷ is independently chosen from H or a C1-C6 alkyl;

R⁸ is independently chosen from H, an alkyl group having from 1 to 6 carbon atoms, a hydroxy group, an alkoxy group having from 1 to 3 carbon atoms, a methacrylate, and an acrylate group;

A is independently chosen from O, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, an alkylene oxide, and a substituted or unsubstituted divalent heterocyclic group having from 5 to 20 carbon atoms;

A′ is independently selected from H, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, a substituted or unsubstituted divalent heterocyclic group having from 5 to 20 carbon atoms, a methacrylate, and an acrylate group;

B is independently selected from O, NH, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, a substituted or unsubstituted divalent heterocyclic group having from 5 to 20 carbon atoms, and a bisphenol A unit; wherein e is an integer from 0 to 1;

D is independently selected from direct bond, a substituted or unsubstituted linear alkyl group having from 1 to 20 carbon atoms, isopropanol, epoxy ring opened unit, a substituted or unsubstituted divalent aromatic group having from 6 to 20 carbon atoms, a substituted or unsubstituted divalent heterocyclic group having from 5 to 20 carbon atoms; or direct bond; and

y is an integer from 1 to 50, from 1 to 20, or from 1 to 10; and x is an integer from 0 to 50, from 1 to 20, or from 1 to 10.

In one embodiment, A may be a divalent hydrocarbon radical or an oxygen atom. The divalent hydrocarbon radical may be a substituted or unsubstituted aliphatic, cyclic, or aromatic containing radical. In one embodiment, the divalent hydrocarbon radical may be chosen from an alkylene, cycloalkylene, alkenylene, or an arylene.

As used herein, the terms “alkylene,” “cycloalkylene,” “alkylene,” “alkenylene,” and “arylene” alone or as part of another substituent refers to a divalent radical derived from an alkyl, cycloalkyl, heteroalkyl, alkynyl, alkenyl, or aryl group, respectively. The respective radicals can be substituted or unsubstituted, linear or branched.

In one embodiment, A is chosen from an oxygen atom, an alkylene (a divalent radical) group having 1 to 10 carbon atoms; an alkylene group having 2 to 8 carbon atoms; or an alkylene group having 4 to 6 carbon atoms. In one embodiment, A is an alkylene group having 1 to 4 carbon atoms, e.g., A may be methylene. In one embodiment, A is a divalent aryl radical having 6 to 30 carbon atoms. In one embodiment, A is a phenyl radical, a tolyl radical, a xylyl radical, etc.

In one embodiment, A is a divalent heterocyclic group (having 5 to 20 carbon atoms). As used herein, the term “heterocyclic” refers to a cyclic compound that has atoms of at least two different elements as members of its ring(s) (e.g., carbon and oxygen). In one embodiment, the compound includes carbon and at least one heteroatom selected from nitrogen, oxygen, sulfur, phosphorus, or a combination of two or more thereof.

In one embodiment, the acrylic functional organic material (ii) is a hydrophilic mono- or multifunctional acrylate selected from a poly(ethyleneoxy)methacrylate, a poly(ethyleneoxy)acrylate, a poly(ethyleneoxy)monomethylether acrylate, a poly(ethyleneoxy)monomethylether methacrylate, a pentaerythritol triacrylate, a glycerol dimethacrylate, a glycerol diacrylate, a bisphenol-A-glycerol tetraacrylate, a bisphenol-A-glycerol diacrylate, a bisphenol-A-ethyleneoxy diacrylate, or a combination of two or more thereof.

Non-limiting examples of suitable acrylic functional organic materials (ii) include:

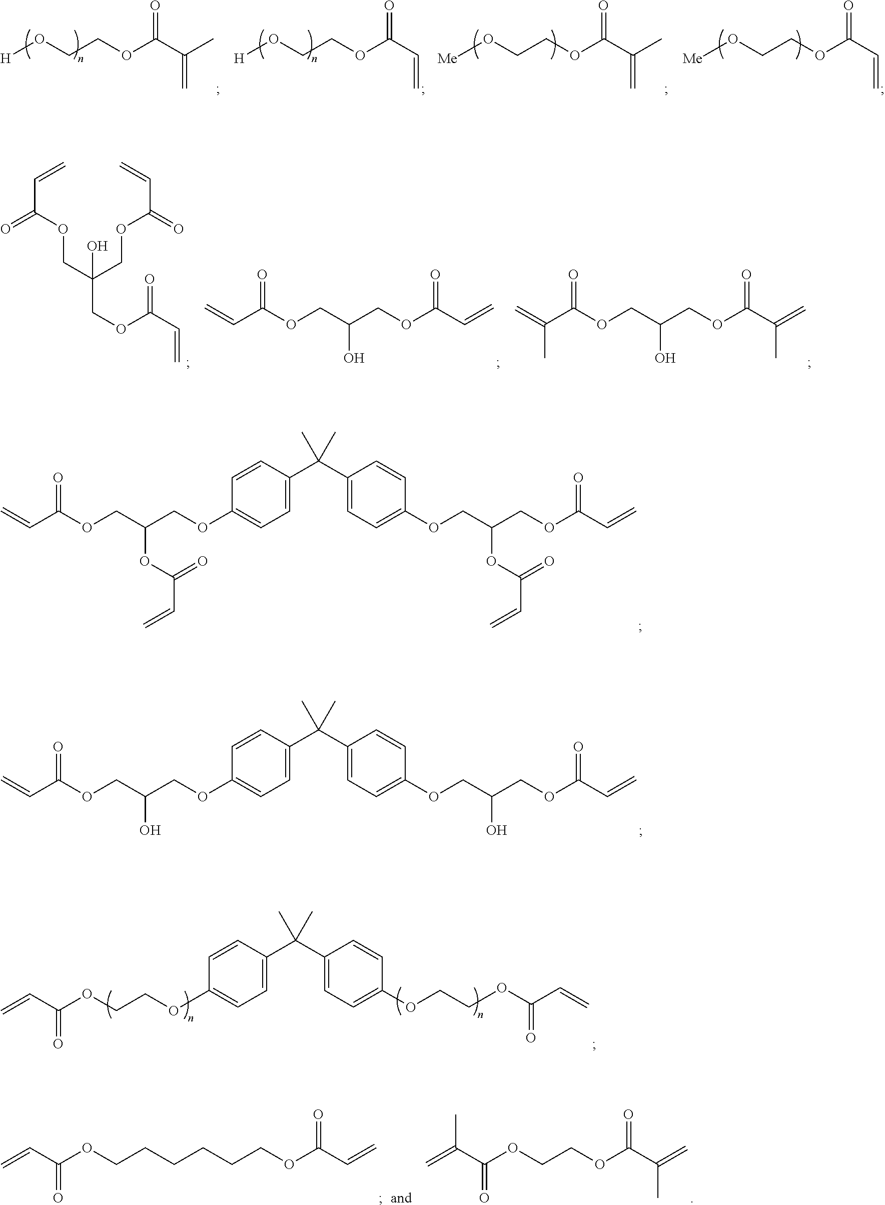

Still other examples of suitable acrylic functional organic compounds include, but are not limited to, Isooctyl Acrylate; 2-2(Ethoxyethoxy)ethyl Acrylate; Isodecyl Acrylate; Isodecyl Methacrylate; Lauryl Acrylate; Lauryl Methacrylate; Isodecyl Acrylate; Propoxylated Neopentyl Glycol Diacrylate; Alkoxylated Difunctional Acrylate Ester; Glycidyl Methacrylate; Propoxylated Neopentyl Glycol Diacrylate; Alkoxylated Difunctional Acrylate Ester; Tridecyl Methacrylate; Tridecyl Acrylate; Caprolactone Acrylate; Tripropylene Glycol Diacrylate; Stearyl Methacrylate; Tris (2-Hydroxy Ethyl) isocyanurate Triacrylate; 1,3-Butylene Glycol Dimethacrylate; 1,3-Butylene Glycol Diacrylate; Neopentyl Glycol Diacrylate; Neopentyl Glycol Dimethacrylate; Ethylene Glycol Dimethacrylate; Alkoxylated Aliphatic Diacrylate Ester; 1,4-Butanediol Diacrylate; 1,4-Butanediol Dimethacrylate; C14-C15 Acrylate Terminated Monomer; Tetrahydrofurfuryl Methacrylate; Hexanediol Diacrylate; 1,6-Hexanediol Dimethacrylate; 1,6-Hexanediol Diacrylate; Tetrahydrofurfuryl Acrylate; Hexanediol Dimethacrylate; Propoxylated Trimethylolpropane Triacrylate; Cyclohexyl Acrylate; Highly Propoxylated Glyceryl Triacrylate; Tetrahydrofurfuryl Acrylate; Cyclohexyl Methacrylate; Triethylene Glycol Dimethacrylate; C14-C15 Methacrylate Terminated Monomer; Tetraethylene Glycol Dimethacrylate; Propoxylated₃ Trimethylolpropane Triacrylate; Diethylene Glycol Diacrylate; Polyethylene Glycol Dimethacrylate; Propoxylated Glyceryl Triacrylate; Triethylene Glycol Diacrylate; Diethylene Glycol Dimethacrylate; Highly Propoxylated Glyceryl Triacrylate; Tetraethylene Glycol Diacrylate; Caprolactone Acrylate; Polyethylene Glycol (200) Diacrylate; Polyethylene Glycol (400) Dimethacrylate; Di-trimethylolpropane Tetraacrylate; Polyethylene Glycol (600) Dimethacrylate; Polyethylene Glycol (400) Diacrylate; Polyethylene Glycol (600) Dimethacrylate; Polyethylene Glycol (600) Diacrylate; Ethoxylated Trimethylolpropane Triacrylate; Ethoxylated₃ Trimethyolopropane Triacrylate; Ethoxylated₆ Trimethylolpropane Triacrylate; Ethoxylated₉ Trimethylolpropane Triacrylate; Ethoxylated₁₅ Trimethylolpropane Triacrylate; Alkoxylated Trifunctional Acrylate Ester; Ethoxylated Trimethylolpropane Triacrylate; Ethoxylated₂₀ Trimethylolpropane Triacrylate; Trimethylolpropane Trimethacrylate; Ethoxylated Trimethylolpropane Triacrylate; Ethoxylated Pentaerythritol Triacrylate; Isobornyl Acrylate; Trimethylolpropane Triacrylate; Trifunctional Methacrylate Ester; Trifunctional Methacrylate Ester; Trifunctional Methacrylate Ester; Isobornyl Acrylate; Isobornyl Methacrylate; Isobornyl Methacrylate; Di-Trimethylolpropane Tetraacrylate; Pentaerythritol Triacrylate; Low Viscosity Aliphatic Diacrylate; Pentaerythritol Tetraacrylate; Dipentaerythritol Pentaacrylate; Low Viscosity Aliphatic Triacrylate Oligomer; Ethoxylated Nonylphenol Acrylate; Phenoxyethyl Methacrylate; 2-Phenoxyethyl Methacrylate; Ethoxylated₁₀ Bisphenol A Diacrylate; Phenoxyethyl Acrylate; 2-Phenoxyethyl Acrylate; Ethoxylated₆ Bisphenol A Dimethacrylate; Ethoxylated₄ Bisphenol A Dimethacrylate; Ethoxylated₄ Bisphenol A Diacrylate; Ethoxylated Bisphenol A Dimethacrylate; Ethoxylated₂ Bisphenol A Dimethacrylate; Ethoxylated Bisphenol A Diacrylate, 1,6 hexane diol diacrylate, N,N, dimethyl acrylamide, etc.

Examples of suitable acrylic functional organic materials include those from Sartomer under the tradenames SR-440; SR-256; SR-395; SR-242; SR-335; SR-313; SR-395; SR-9003; SR-9040; SR-379; SR-9003; SR-9040; SR-493; SR-489; SR-495; SR-306; SR-324; SR-368; SR-297; SR-212; SR-247; SR-248; SR-206; SR-306; SR-9209; SR-213; SR-214; SR-2000; SR-203; SR-238; SR-239; SR-238; SR-285; SR-239; SR-501; SR-208; SR-9021); SR-203; SR-285; SR-220; SR-205; SR-2100; SR-209; SR-492; SR-230; SR-210; SR-9020; SR-272; SR-231; SR-9021; SR-268; SR-495; SR-259; SR-603; SR-355; SR-252; SR-344; SR-252; SR-610; SR-454; SR-454; SR-499; SR-502; SR-9035; SR-9008; SR-9035SR-415; SR-350; SR-415; SR-494; (e.g., SR-506; SR-351; SR-9010; SR-9010; SR-9011; SR-506; SR-423; SR-423; SR-355; SR-444; CN-132; SR-295; SR-399; CN-133; SR-504; SR-340; SR-340; SR-602; SR-339; SR-339; CD-541; CD-540; SR-601; SR-348; SR-348; SR-349, etc. Other examples include, but are not limited to, acrylate monomers available from Eternal Chemical Co., Ltd. such as those under the tradenames EM210, EM2103, EM2104, EM212, EM 219, EM223, EM221, EM222, EM223, EM2251, EM 231, EM235, EM2380, EM2387, EM241, EM265. Examples of suitable bisphenol-A-epoxy acrylates include, but are not limited to, those available from SK CYTEC under the tradenames EB-3701, EB-2958, EB-2959, EB-3600, EB-3700, EB-600, EB-9604 and EB-9608. Examples of suitable polyester acrylate oligomer include, but are not limited to, those available from SK CYTEC under the tradenames EB-1657, EB-1810, EB-1870, EB-2870, EB-3438, EB-436, EB-438, EB-450, EB-505, EB-524, EB-525, EB-584, EB-585, EB-586, EB-588, EB-657, EB-770, EB-80, EB-800, EB-81, EB-810, EB-811, EB-812, EB-813, EB-83, EB-830, EB-84, EB-840, EB-850, EB-870 and EB-880.

The acrylic functional organic material (ii) may be present in an amount of from about 2 wt. % to about 40 wt. % based on the weight of a dry film formed from the composition; from about 5 wt. % to about 30 wt. % based on the weight of a dry film formed from the composition; even from about 10 wt. % to about 25 wt. % based on the weight of a dry film formed from the composition.

The acrylic functional urethane material (iii) may be chosen from a urethane compound comprising one or more acrylate functional groups. The acrylic functional urethane material may also be referred to herein as a urethane acrylate. In embodiments, the urethane acrylate is a multifunctional urethane acrylate comprising two or more acrylate functional groups; three or more acrylate functional groups; four or more acrylate functional groups; five or more acrylate functional groups; or six or more acrylate functional groups.

Suitable urethane acrylates may be made by the initial reaction of an aliphatic diisocyanate of the formula OCN—R—NCO with an aliphatic polyol. In one embodiment, the diisocyanate is a cycloaliphatic diisocyanate such as isophorone diisocyanate. The polyol may be an aliphatic diol, in which case the reaction yields a diisocyanate. Reaction of the diisocyanate with a hydroxyl substituted acrylate, (e.g. pentaerythritol triacrylate) yields a urethane acrylate oligomer. For example, the multifunctional urethane acrylate oligomer may be formed from an aliphatic polyester or polyether polyol prepared from condensation of a dicarboxylic acid, e.g., adipic acid or maleic acid, and an aliphatic diol, e.g. diethylene glycol or 1,6-hexane diol. In one embodiment, the polyester polyol may comprise adipic acid and diethylene glycol. The multifunctional isocyanate may comprise methylene dicyclohexylisocyanate or 1,6-hexamethylene diisocyanate. The hydroxy-functionalized acrylate may comprise a hydroxyalkyl acrylate such as 2-hydroxyethyl acrylate, 2-hydroxypropyl acrylate, 4-hydroxybutyl acrylate, or polyethylene glycol acrylate. In one embodiment, the urethane acrylate oligomer may comprise the reaction product of a polyester polyol, methylene dicyclohexylisocyanate, and hydroxyethyl acrylate.

In one embodiment, the urethane acrylate is chosen from an aliphatic polyether urethane acrylate or acrylic ester. The urethane acrylate may have a glass transition temperature (T_{g}) value from −80° C. to −10° C. In one embodiment, the urethane acrylate comprises a UV-curable group of an acrylate or an (alkyl)acrylate, and may have a viscosity ranging from 5,000 to 500,000 mPa at 25° C. at a shear rate of 2.55 s⁻¹, measurable by HAAKETM Rotational Rheometer with a cone plate (35 mm diameter). The T_{g} can be determined by differential scanning calorimetry (DSC), which is well known to the person skilled in the art. In one embodiment, the glass transition temperature is determined by DSC at a heating rate of 10° C./min.

In one embodiment, the urethane acrylate comprises a multifunctional polyether (alkyl)acrylate oligomer. The multifunctional polyether (alkyl)acrylate oligomer may comprise at least two (alkyl)acrylate groups, e.g., from 2 to 10 (alkyl)acrylate groups.

Examples of suitable commercially available urethane acrylates include multiacrylates with a functionality of at least five, such as, but not limited to, urethane hexaacrylates such as CN968, CN9010, CN9030, available from Sartomer; Ebecryl 8301, Ebecryl 1290, and Ebecryl 8702, available from Cytec; BR-941, available from Bomar; Etercure 6145, available from Eternal; and Miramer PU610, available from Miwon. Urethane acrylates with functionality higher than 6 may also be used. These include, but are not limited to, BR-991 urethane nonaacrylate, available from Bomar; CN9013 urethane nonaacrylate, available from Sartomer; and Miramer PU9800 nonaacryalte, available from Miwon.

Other suitable urethane acrylates, which can be used include, for example, aliphatic polyether urethane diacrylates, such as, but not limited to, BR-3042, BR-3641 AA, BR-3741 AB, and BR-344 available from Bomar Specialties Co., Torrington, Conn.

Other suitable aliphatic urethane acrylates include, but are not limited to, CN-9002, CN9014 NS, CN-980, CN-981, CN-9019 available from Sartomer. Urethane acrylate resins such as Genomer 4188/EHA, Genomer 4269/M22, Genomer 4425, and Genomer 1122, Genomer 6043 from Rahn AG, Switzerland are also suitable for the compositions. Aliphatic urethane acrylates like UV-36301D80, UV-NS054, and UV-NS077 from Nippon Soda, Tokyo, Japan are also suitable. Difunctional aliphatic polyester urethane acrylate oligomers as well as difunctional aliphatic polyester/ether urethane acrylate oligomers are also suitable urethane acrylates.

Still other examples of suitable multifunctional urethane acrylates include, but are not limited to urethane acrylates, such as Bomar® BR-5825, BR-7432G, BR-446, BR-970, BR-3641AA, BR-541, BR-7632G, BR-372, BR-374, or melamine acrylates, such as Bomar BMA-200. Another example of urethane acrylate resin that can be used in the present invention is Sartomer® CN-991. Still other examples of suitable urethane acrylates include those sold under the names of UCECOAT® 7155, UCECOAT® 7177, UCECOAT® 7570, UCECOAT® 7571, UCECOAT® 7578, UCECOAT® 7655, UCECOAT® 7674, UCECOAT® 7689, UCECOAT® 7770, UCECOAT® 7772, UCECOAT® 7773, UCECOAT® 7825 and UCECOAT® 7849.

Still other examples of suitable urethane acrylates include, but are not limited to, those available from SK CYTEC under the tradenames EB-1259, EB-1290, EB-2001, EB-2002, EB-2003, EB-204, EB-205H, EB-210, EB-220, EB-2220, EB-230, EB-244, EB-245, EB-254, EB264, EB-265, EB-270, EB4830, EB-4833, EB-4835, EB-4842, EB-4858, EB-4866, EB-4883, EB-5129, EB-6602, EB-8200, EB8210, EB-8301, EB-8402, EB-8800, EB-8803, EB-8804, EB-9017, EB-9019, EB-9206, EB9215, EB-9216, EB-9260, EB-9264, EB-9269, EB-9270 and EB-9970; those available from Nipponkayaku Co. Ltd. under the tradenames UX-2201, UX-2301, UX-3204, UX-3301, UX-4101, UX-6101, UX-7101, UX-8101, DPHA-40H, MU-2100 and MU4001; those available from QENTOP under the tradenames QU-1600, QU-1620, QU-1650, QU-1700, QU-1800, QU-1810, QU-200, QU-201, QU-2010, QU-2040, QU-2050, QU-2060, QU-2070, QU-2080, QU-2090, QU-210, QU-211, QU-220, QU-2200, QU-2300, QU-300, QU-3010, QU-3011, QU-310 and QU-700; DR U050M 1 available from Eternal Materials Co. LTD; UVU 9445 available from Kromachem, German, etc.

The acrylic functional urethane material (iii) may be present in an amount of from about 5 wt. % to about 98 wt. % based on the weight of a dry film formed from the composition; from about 10 wt. % to about 75 wt. % based on the weight of a dry film formed from the composition; or from about 20 wt. % to about 50 wt. % based on the a weight of a dry film formed from the composition.

The curable composition optionally comprises metal oxide particles (iv). The metal oxide particles used in the composition of the invention are not particularly limited. Suitable examples include, but are not limited to, cerium oxide particles, titanium oxide particles, zinc oxide particles, silica oxide particles, tin oxide particles, aluminum oxide particles, or a combination of two or more thereof In one embodiment, the metal oxide nanoparticles are silica nanoparticles.

The size of the metal oxide particles may be selected as desired for a particular purpose or intended application. In embodiments, the metal oxide particles are nanosized particles. Sample was dispersed into water/solvent reservoir to get appropriate response before the measurement. Nanoparticles may have dimensions in the range of one to about 500 nanometers. For clear coat applications, the particles should have a size below a certain limit such that it will not scatter light passing through the coating. Particles with dimensions less than λ/2 do not scatter light of λ, where λ is the wavelength of light, and will not disrupt the transparency of the matrix in which they are incorporated. Particle size can be measured using light scattering measurements (for example, via a 802-DLS instrument from Viscotek). In embodiments, the metal particles have a mean diameter of 190 nanometers or less. In other embodiments, the metal particles have a diameter of from about 1 nm to about 190 nm; from about 5 nm to about 175 nm; from greater than 25 nm to about 150 nm; or from about 50 nm to about 100 nm. Here as elsewhere in the specification and claims, numerical values may be combined to form new and non-disclosed ranges.

The metal oxide nanoparticles surface-modified with an organofunctional silane moiety, where in the amount of silane used for functionalization of metal oxide nanoparticles from about 0.1 to about 40 wt. %, preferably from about 0.1 to about 20 wt. %, more preferably from about 0.5 to about 10 wt. %, and most preferably from about 1 wt % to about 10 wt %, all based on the total weight of the nanoparticles. Here as elsewhere in the specification and claims, numerical values may be combined to form new and non-disclosed ranges.

The curable compositions may include one or more solvents in which the various components are dispersed. A variety of solvents may be employed. For example, hydrocarbon solvent, alcoholic solvent, ether solvent, amide solvent, cyclic urea solvent, and halohydrocarbon solvent may be employed. Examples of the hydrocarbon solvent include n-hexane, n-pentane, benzene, toluene, and xylene. Examples of the alcoholic solvent include C1-C4 alcohols such as methanol, ethanol, propanol, isopropanol (IPA), n-butanol, and t-butanol. Examples of the ether solvent include diethyl ether, diisopropyl ether (IPE), methyl t-butyl ether (MTBE), tetrahydrofuran (THF), cyclopentyl methyl ether, dimethoxyethane, and 1,4-dioxane. Examples of the amide solvent include dimethylformamide (DMF), dimethylacetamide (DMAc), and N-methyl-2-pyrrolidone (NMP). Examples of the cyclic urea solvent include 1,3-dimethyl-2-imidazolidinone (DMI) and 1,3-dimethyl-3,4,5,6-tetrahydro-2(1H)-pyrimidinone (DMPU). Examples of the halohydrocarbon solvent include chloroform, methylene chloride, and 1,2-dichloroethane (EDC). Other than these solvents, water, dimethylsulfoxide (DMSO), sulfolane, acetonitrile, (C1-C4 alkyl)acetate esters such as ethyl acetate, and acetone may be used. These solvents may be used alone or in combination of two or more species.

Among these solvents, C1-C4 alcohol solvents such as methanol, ethanol, propanol, isopropanol (IPA), n-butanol, and t-butanol are particularly suitable for the compositions.

The composition may also include a surfactant. The surfactant may be an ionic surfactant, a non-ionic surfactant, or may comprise a mixture thereof. In one embodiment, the composition comprises a non-ionic surfactant. Suitable non-ionic surfactants include, but are not limited to, alkyl polyether alcohols such as linear or branched polyoxyethylene alcohols. For example, the non-ionic surfactant may be an alkyl polyether alcohol comprising (a) from about 8 to about 30, in one embodiment from about 8 to about 20, carbon atoms, and (b) about 3 to about 50 moles, in one embodiment about 3 to about 20 moles, ethylene oxide. Further examples of non-ionic surfactants include, but are not limited to, polyoxyethylene sorbitan monopalmitate, polyoxyethylene sorbitan monostearate, polyoxyethylene sorbitan monooleate, linear alcohol alkoxylates, alkyl ether sulfates, dioxane, ethylene glycol and ethoxylated castor oils such as polyethylene glycol castor oil, dipalmitoylphosphatidylcholine (DPPC), ethylene oxide sulfonates and highly substituted benzene sulfonates.

In one embodiment, the non-ionic surfactant is chosen from an ethoxylated alcohols. Exemplary of these ethoxylated alcohols are ethoxylates of alkyl polyethylene glycol ethers including a C₁₀ alcohol ethoxylate, such as a C₁₀ alcohol ethoxylate which contains eight ethylene oxide units.

Suitable anionic surfactants include, but are not limited to, alkyl ether sulfates, alkylsulfonates, alkylisothionates and alkyltaurates or their salts, alkylcarboxylates, alkyl sulphosuccinates or alkylsuccinamates, alkylsarcosinates, alkylated derivatives of protein hydrolysates, acylaspartates, and alkyl and/or alkylether and/or alkylarylether ester phosphates and phosphonates. The cation is generally an alkali or alkaline-earth metal such as sodium, potassium, lithium, magnesium or an ammonium group NR₄⁺ where R, which may be identical or different, represents an alkyl and/or aryl group which may or may not be substituted by an oxygen or nitrogen atom.

Exemplary anionic surfactants include, but are not limited to, alpha-olefin sulfonates that are salts of a monovalent cation such as an alkali metal ion like sodium, lithium or potassium, an ammonium ion or an alkyl-substituent or hydroxyalkyl substitute ammonium in which the alkyl substituents may contain from 1 to 3 carbon atoms in each substituent. The alpha-olefin moiety typically has from 12 to 16 carbon atoms. The alkyl ether sulfate may be an alkylpolyether sulfate and contains from 8 to 16 carbon atoms in the alkyl ether moiety. Preferred as anionic surfactants are sodium lauryl ether sulfate (2-3 moles ethylene oxide), C₈-C₁₀ ammonium ether sulfate (2-3 moles ethylene oxide) and a C₁₄-C₁₆ sodium alpha-olefin sulfonate and mixtures thereof. An example of a suitable sulfate is an ammonium ether sulfate.

The composition may also comprise a photoinitiator. The photoinitiator is not particularly limited and can be chosen as desired for a particular purpose or intended application. Examples of suitable photoinitiators include, but are not limited to, benzophenones, phosphine oxides, nitroso compounds, acryl halides, hydrazones, hydroxy ketones, amino ketones, mercapto compounds, pyrillium compounds, triacrylimidazoles, benzimidazoles, chloroalkyl triazines, benzoin ethers, benzil ketals, thioxanthones, camphorquinone, and acetophenone derivatives.

In one embodiment, the photoinitiator is chosen from an acylphosphine. The acyl phosphine can be a mono- or bis-acylphoshine. Examples of suitable acylphosphine oxides include those described in U.S. Pat. No. 6,803,392, which is incorporated herein by reference in its entirety.

Specific examples of suitable acylphosphine photoinitiators include, but are not limited to, diphenyl(2,4,6-trimethylbenzoyl)phosphine oxide (DAROCUR® TPO), diphenyl(2,4,6-trimethylbenzoyl)phosphine oxide (ESACURE® TPO, LAMBERTI Chemical Specialties, Gallarate, Italy), diphenyl(2,4,6-trimethylbenzoyl)phosphine oxide (FIRSTCURE® HMPP available from Albemarle Corporation, Baton Rouge, La.), diphenyl(2,4,6-trimethylbenzoyl)phosphine oxide (LUCIRIN® TPO, available from BASF (Ludwigshafen, Germany), diphenyl(2,4,6-trimethylbenzoyl)phosphinate (LUCIRIN® TPO-L), phenyl bis(2,4,6-trimethyl benzoyl)phosphine oxide (IRGACURE® 819, available from Ciba Specialty Chemicals, Tarrytown, N.Y.), and bis(2,6-di-methoxybenzoyl)-2,4,4-trimethylpentylphosphine oxide (as IRGACURE® 1700, IRGACURE® 1800 and IRGACURE® 1850 in admixture with a-hydroxyketones from Ciba Spezialitätenchemie).

Examples of α-hydroxyketone photoinitiators can include 1-hydroxy-cyclohexylphenyl ketone (IRGACURE® 184), 2-hydroxy-2-methyl-1-phenyl-1-propanone (DAROCUR® 1173), and 2-hydroxy-1-[4-(2-hydroxyethoxy)phenyl]-2-methyl-1-propanone (IRGACURE® 2959), all available from Ciba Specialty Chemicals (Tarrytown, N.Y.).

The composition may optionally include a photoinitiator. Examples of α-aminoketones photoinitiators can include 2-benzyl-2-(dimethylamino)-1-[4-(4-morpholinyl)phenyl]-1-butanone (IRGACURE® 369), and 2-methyl-1-[4-(methylthio)phenyl]-2-(4-morpholinyl)-1-propanone (IRGACURE® 907), both available from Ciba Specialty Chemicals (Tarrytown, N.Y.).

The composition may also include a thermal initiator. The type of thermal initiator is not particularly limited and can be chosen as desired for a particular purpose or intended application. Examples of suitable thermal initiators include, but are not limited to, 2,2′-azobis (2,4-dimethylpentanenitrile), 2,2′-azobis (2-methylpropanenitrile), 2,2′-azobis (2-methylbutanenitrile), peroxides such as benzoyl peroxide, and the like. Exemplary thermal initiators are azobisisobutyronite (AIBN) and 1,1′-Azobis(cyclohexanecarbonitrile).

The antifog composition may be applied to suitable polymeric substrates that may include, but are not limited to, organic polymeric materials such as acrylic polymers, e.g., poly(methylmethacrylate), polyamides, polyimides, acrylonitrile-styrene copolymer, styrene-acrylonitrile-butadiene terpolymers, polyvinyl chloride, polyethylene, polycarbonates, copolycarbonates, high-heat polycarbonates, and any other suitable material.

The antifog composition may be applied to the substrate as a film or coating that has a thickness (e.g., dry film thickness) in a range of about 0.5 μm to about 25 μm; in another embodiment from about 1 μm to about 20 μm; in yet another embodiment from about 1 μm to about 25 μm; in still yet another embodiment from about 0.5 μm to about 20 μm; in a further embodiment from about 1 μm to about 15 μm; in an even further embodiment from about 1 μm to about 10 μm; or in still an even further embodiment from about 1 μm to about 5 μm. In one embodiment, the film or coating has a thickness in a range of about 4 μm to about 20 μm; in another embodiment from about 5 μm to about 25 μm; in yet another embodiment from about 5 μm to about 25 μm; in still yet another embodiment from about 5 μm to about 20 μm; in a further embodiment from about 5 μm to about 15 μm; or in yet another further embodiment from about 5 μm to about 10 μm. In an embodiment, the film or coating has a thickness of less than about 50 μm; and in another embodiment less than about 30 μm.

The antifog composition may be UV cured after applying the formulation onto a suitable polymeric substrate (e.g., polycarbonate substrates).

The composition may be cured using any suitable irradiation source. In embodiments, the irradiation source is an ultraviolet source providing light whose wavelength is in the range of preferably from 180 to 600 nm, more preferably 190-500 nm, are used. The light- irradiation intensity (radiation dose*exposure time per unit of volume) is selected as a function of the selected process, of the selected composition of the temperature of the composition in such a way as to give a sufficient processing time. Commercially available irradiation sources may be used in the irradiation step of the present invention. Examples of suitable sources include those available from Dymax. The source may have an output of from about 200 to about 1,000 mJ/cm² at about 120 to about 200 mW/cm². Other available light sources include those available from UV Fusion. Average exposure times (time which is required to pass the irradiation unit(s)) is for example at least 1 second, preferably 2 to 50 seconds. For instance, the disclosed composition may be cured by actinic radiation in the ultraviolet (UV) or visible spectrum, both of which can encompass actinic radiation or by electron beam (EB) radiation.

As previously described, the present antifog compositions can be used to coat a variety of substrates. The compositions are particularly suitable to provide a coating to prevent or substantially limit fogging of such substrates. As such, substrates coated with the present antifog coating compositions may be used in a variety of applications including, but not limited to, automobile headlights, windshields, eyeglasses, goggles, mirrors, storage containers, windows, camera lens, etc.

In one embodiment, the coating formed from the compositions may have a transmittance of about 85% or greater; about 89% or greater; about 92% or greater; even about 95% or greater. The optical properties such as % transmittance and haze may be measured by any suitable method. In embodiments, optical properties may be measured using the BYK Gardner Haze guard. Optical properties may be measured at different locations in a sample and the average value is taken along with the standard deviation of the measurements. The optical characteristics (Transmission and Haze) may be measured using a BYK Gardner haze guard instrument measurements were made according to ASTM D1003.

The compositions of this invention may be prepared by simply blending the various reagents in the desired proportions. If solvents are present, volatiles may be removed by conventional operations such as vacuum stripping. The composition may then be applied by conventional techniques such as dipping, spraying, brushing, roller coating or flow coating to the substrate (e.g., a polycarbonate, polyester or an acrylic resin such as poly(methyl methacrylate) or other substrate of interest). The coating thus formed preferably has a thickness in the range of about 3-25 and typically about 10 microns.

Following application of the coating composition to the substrate, the composition is cured in air by exposure to suitable radiation, typically ultraviolet radiation. Curing temperatures are not critical but may be within the range of about 25° to 70° C. It is often convenient to employ a continuous line for coating and curing. Resinous articles coated with the compositions of this invention, as well as during products thereof, are other aspects of the invention.

The following examples are illustrative and not to be construed as limiting of the technology as disclosed and claimed herein.

### EXAMPLES

### Materials

Silicone Polyether Acrylate, Silicone dimethacrylate, Functionalized colloidal silica (FCS), were obtained from Momentive Performance Materials Inc., LUCIRIN® TPO, obtained from BASF (Ludwigshafen, Germany), IRGACURE® 184, obtained from Ciba Specialty Chemicals (Tarrytown, N.Y.).Urethane acrylate (DR U050M1), EB 80 from Allnex, Mecostat® 724, 749 from MECO GmbH, Germany, Tegorad 2300 from Evonik, Ecosurf™ EH-9 from Dow Chemical International Private Ltd. (Mumbai), Ethylene Glycol Dimethacrylate, Bisphenol-A-ethoxylate diacrylate, 1-Methoxy-2-propanol, Isopropyl alcohol and ethyl acetate were procured from Sigma Aldrich Chemicals.

### Preparation of Coating Formulation

Different components of the formulations were weighted in a glass vial along with solvents such as 1-methoxy 2-propanol, IPA, ethyl acetate, or a combination of solvents. The components were mixed well in a vortex before coating on the polycarbonate substrate. The detailed compositions are presented in the various tables below.

### Preparation of Coated Polycarbonate Panels

The prepared curable formulations were coated on polycarbonate plates according to the following procedure. Polycarbonate (PC) plates were cleaned with a stream of N₂ gas to remove any dust particles adhering to the surface followed by rinsing of the surface with isopropanol. The plates were then allowed to dry inside the fume hood for 20 minutes. The formulations were then applied to the PC plates by flow coating. The solvent in the primer coating solutions were allowed to flash off in the fume hood for approximately 5 minutes (22° C., 37% RH) and then put in an oven for 75° C. for 5 minutes. After that it was UV cured in UV Dymax or UV fusion. Curing in UV Dymax was done by varying the time till the coating gets completely cured. For coating from example 1 to 8, the coating was cured in UV Dymax with UVA 7505 mJ/cm², 37 mW/cm². Curing in UV fusion was done by varying the power, speed, and number of passes to get a completely cured sample. For coating from Example 9 to 19, UVA was maintained at 200 to 1000 mJ/cm² at 120-200 mW/cm².

### Measurement of Coating Properties

Optical Properties

The optical properties such as % transmittance and Haze of the coated PC panels was measured using the BYK Gardner Haze guard. Optical properties were measured at five different locations in a sample and the average value is taken along with the standard deviation of the measurements. The optical characteristics (Transmission and Haze) were measured using a BYK Gardner haze guard instrument measurements were made according to ASTM D1003.

Antifog Measurement

Antifog property was measured as follows. A coated sample was kept 5 cm above the water surface of a warm water bath maintained at 60° C. With the coated surface of the sample facing down, the coating was exposed to the steam from a water bath for 30 seconds and visually inspected for the optical clarity of the coating. If the coating fogs or develop haziness during testing it is ranked as “fail.” If the coating maintains optical clarity for 30 seconds, the coating is ranked as “pass.”

Gloss Measurement

Coated samples were put in a ziplock bag while storing them on a bench top under room temperature (23° C.) and humid condition (RH of 60 to 80% RH). In some of the coatings, change in gloss and appearance was observed. Gloss of coating was measured using BYK Micro TriGloss, which can measure the gloss at angles of 20°, 60°, and 85° as per ASTM D 2457.

Cross-Hatch Adhesion Test

The adhesion of the coated PC samples was tested by Cross-hatch adhesion test. The test involves marking cross-hatch indent pattern in the coated samples using a cross-hatch cutter over the surface of the panels. An adhesive tape (3M scotch 898NR) was pasted over the square pattern and pulled apart from the surface at 90 degree angle. The cross-hatch indent was examined for any peeled off squares. The rating was given from 5B to 0B, with 5B indicating highest adhesion with none of the squares being affected by the test. The sample is rated 4B if less than 5% of the total area inside the squares were affected by the peel test. More than 35% damage is rated as 0B.

Watersoak Test

After subjecting the panels for cross-hatch adhesion test, the panels were immersed in distilled water maintained at 65° C. The samples were brought to room temperature and wiped with soft tissue paper to remove any water drop adhering to the surface. They are allowed to sit for 1 hour in air (23° C.) to dry them completely. The samples were then rated for adhesion by repeating the Peel test (as done in the cross-hatch adhesion test) at several days interval. The control sample was also used in all the experiments.

Compositions and properties of the different coatings are presented in the tables. Optical properties of all coated panels were measured to correlate to optical properties of initial coating. The thickness of the coatings was also measured. Since thickness of the coatings was varied from top to bottom, the range of thickness is reported.

TABLE 1 (a)
Composition and properties of coating

| Component | Composition (wt %) | Ex-1 | Ex-2 | Ex-3 | Ex-4 | Ex-5 | Ex-6 | Ex-7 |
|---|---|---|---|---|---|---|---|---|
| Pentaerythritol | | 99.2 | 87.7 | 87.6 | 80.5 | 96.7 | 92.76 | 45.5 |
| triacrylate | | | | | | | | |
| Silicone | TR 2300 | | 8.77 | 8.76 | 16.1 | | | 45.5 |
| polyether | | | | | | | | |
| acrylate | | | | | | | | |
| | EGDMA | | | | | | | 4.5 |
| | Mecostat ®-724 | | | 1.58 | 1.45 | 1.74 | 5 | |
| Photoinitiator | LUCIRIN ® TPO | 0.79 | 3.51 | 2.1 | 1.93 | 1.55 | 2.23 | 4.5 |
| | Properties of coating | | | | | | | |
| | % T | 89.5 | 89.3 | 89.2 | 89.1 | 89 | 89.1 | 89.3 |
| | Haze | 0.5 | 0.45 | 0.46 | 0.53 | 0.62 | 0.43 | 0.6 |
| | Antifog | Fail | Fail | Fail | Pass | Pass | Pass | Pass |

TABLE 2
Composition and properties of coating

| Component | Composition (wt %) | | Ex-7 | Ex-8 | Ex-20 |
|---|---|---|---|---|---|
| Pentaerythritol | | | 45.5 | 45.5 | 45.5 |
| triacrylate | | | | | |
| Silicone | TR 2300 (Silicone | m = 30, | 45.5 | | |
| polyether | polyether acrylate) | n = 21 | | | |
| acrylate | | | | | |
| Silicone | (Silicone polyether | m = 18, | | 45.5 | |
| polyether | acrylate) | n = 8 | | | |
| acrylate | | | | | |
| Urethane | DR U050M1 | | | | 45.5 |
| acrylate | | | | | |
| | EGDMA | | 4.5 | 4.5 | 4.5 |
| | Mecostat ®-724 | | | | |
| Photoinitiator | LUCIRIN ® TPO | | 4.5 | 4.5 | 4.5 |

| Properties of Coating | | | |
|---|---|---|---|
| % T | 89.3 | 89.3 | 88.9 |
| Haze | 0.6 | 0.55 | 0.43 |
| Thickness (μm) | 3.5 | 3.65 | 6.8 |
| Antifog | Pass | Pass | Fail |

TABLE 3
Composition and Properties of Coating

| | Composition | | | | |
|---|---|---|---|---|---|
| Component | (wt %) | Ex-9 | Ex-10 | Ex-11 | Ex-12 |
| Urethane acrylate | DR U 050M1 | 98.25 | 69.31 | 66.83 | 64.36 |
| diacrylate | | | | | |
| Pentaerythritol | | | 23.76 | 23.76 | 23.76 |
| triacrylate | | | | | |
| Silicone | | | | 2.48 | 4.95 |
| dimethacrylate | | | | | |
| Ethoxylated (4) | | | 4.95 | 4.95 | 4.95 |
| Bisphenol A | | | | | |
| diacrylate | | | | | |
| Photoinitiator | Irgacure ®-184 | 1.75 | 1.98 | 1.98 | 1.98 |
| | Properties of Coating | | | | |
| | % T | 89.5 | 89.1 | 89.1 | 89 |
| | Haze | 0.49 | 0.69 | 0.2 | 0.4 |
| | Thickness, um | 9.9-13.9 | 8.5-10.4 | 8.8-12.6 | 8.3-12.5 |
| | Antifog | Pass | Pass | Pass | Pass |

TABLE 4

| Component | Composition | Ex-13 | Ex-14 |
|---|---|---|---|
| Urethane acrylate | DR U 050M1 | 66.83 | 64.36 |
| diacrylate | | | |
| Amine modified | EB 80 | 23.76 | 23.76 |
| polyester | | | |
| tetraacrylate | | | |
| Ethoxylated (4) | | 4.95 | 4.95 |
| Bisphenol A | | | |
| diacrylate | | | |
| Silicone | | 2.48 | 4.95 |
| dimethyacrylate | | | |
| Ethoxylated (15) | SR 9035 | | |
| Trimethylolpropane | | | |
| Triacrylate | | | |
| Photoinitiator | Irgacure ®-184 | 1.98 | 1.98 |
| | Properties of Coating | | |
| | % T | 89.2 | 88.4 |
| | Haze | 0.3 | 0.24 |
| | Thickness, um | 10.1-14.3 | 11.1-13.9 |
| | Antifog | Pass | Fail |

TABLE 5

| Composition (wt %) | Ex. 15 |
|---|---|
| UVU9445 | 46.8 |
| Pentaerythritol triacrylate | 37.5 |
| LUCIRIN ® TPO | 4.5 |
| Mecostat ® 749 | 11.2 |

Properties of Coating

| | |
|---|---|
| % T | 88.5 |
| Haze | 0.65 |
| Antifog | Pass |

TABLE 6

| Composition | | | | |
|---|---|---|---|---|
| (wt %) | Ex. 16 | Ex. 24 | Ex. 7 | Ex. 17 |
| CN 991 | 31.21 | 18.15 | | |
| DR U050m1 | 31.21 | 36.30 | | |
| UVU9445 | | | | 7.4 |
| Pentaerythritol | 31.21 | 36.30 | 45.5 | 43.8 |
| triacrylate | | | | |
| TEGO ®RAD | | | 45.5 | 43.8 |
| 2300 | | | | |
| LUCIRIN ® TPO | | | 4.5 | 5 |
| Irgacure ®-184 | 2.34 | 2.72 | | |
| EGDMA | | | 4.5 | |
| Ecosurf ™ EH-9 | 4.01 | 6.52 | | |

Properties of Coating

| | | | | |
|---|---|---|---|---|
| Optical | Ok | Ok | Ok | Ok |
| Antifog | Pass | Pass | Pass | Pass |

TABLE 7

| Composition | | | | | | |
|---|---|---|---|---|---|---|
| (wt %) | Ex. 10 | Ex. 18 | Ex. 19 | Ex. 21 | Ex. 22 | Ex. 23 |
| DR U 050M1 | 69.31 | 69.31 | 66.83 | 64.36 | 64.36 | 41.21 |
| Pentaerythritol | 23.76 | | 23.76 | 23.76 | 23.76 | 24.12 |
| triacrylate | | | | | | |
| EB 80 | | 23.76 | | | | |
| SR 9035 | | | | | | 20.10 |
| Silicone | | | | | | 2.51 |
| dimethacrylate | | | | | | |
| Functionalized | | | 2.48 | 4.95 | 10.34 | 10.05 |
| silica (FCS) | | | | | | |
| Ethoxylated (4) | 4.95 | 4.95 | 4.95 | 4.95 | | |
| Bisphenol A | | | | | | |
| diacrylate | | | | | | |
| Irgacure ®-184 | 1.98 | 1.98 | 1.98 | 1.98 | 1.97 | 2.01 |
| % T | 89.1 | 89.2 | 88.90 | 88.90 | 88.9 | 89 |
| Haze | 0.69 | 0.31 | 0.29 | 0.34 | 0.38 | 0.74 |
| Thickness (μm) | 8.5-10.4 | 10-14 | 9.3-14.9 | 8.2-13 | 8.1-12.4 | 10.9-15.1 |
| Antifog | Pass | Pass | Pass | Pass | Pass | Pass |

TABLE 8
Water Soak Adhesion study of coating

| | 65° C. Water Soak | | | | | | |
|---|---|---|---|---|---|---|---|
| Samples | Initial | 1 hr | 2 hrs | 3 hrs | 2 days | 4 d | 5 d |
| Ex. 9 | 5B | 0B | | | | | |
| Ex. 10 | 5B | 0B | | | | | |
| Ex. 21 | 5B | 5B | 5B | 5B | 5B | 0B | |
| Ex. 17 | 5B | 5B | 5B | 5B | 5B | — | — |
| Ex. 7 | 5B | 5B | 5B | 5B | 5B | 5B | 5B |

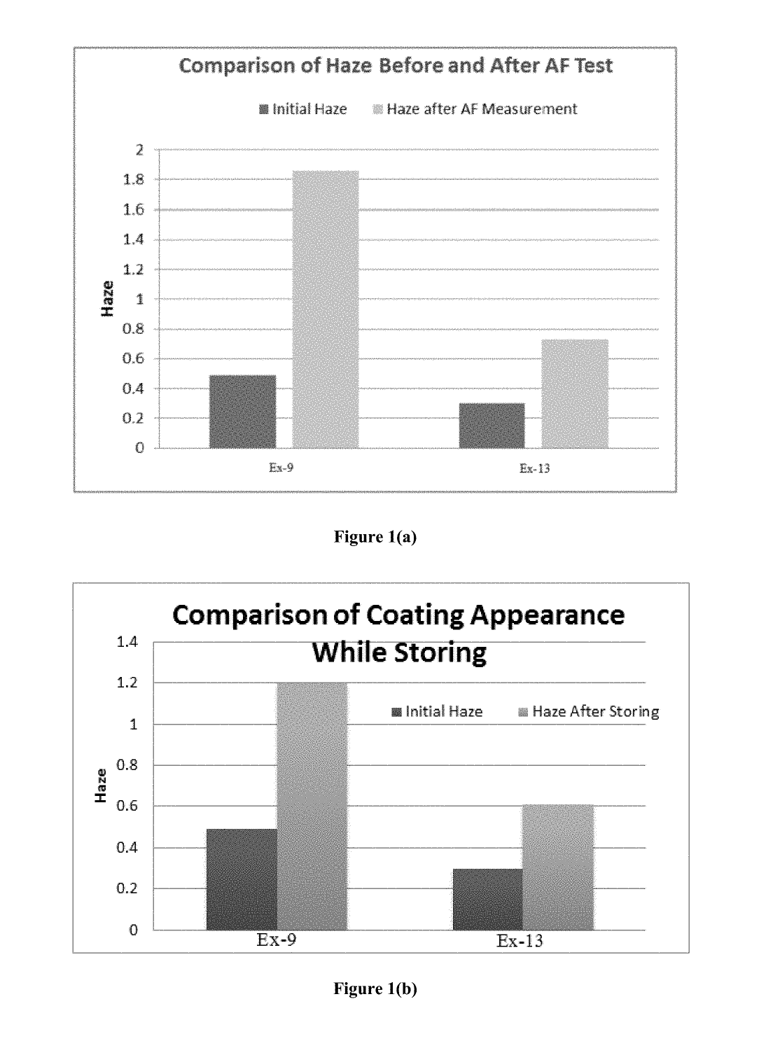

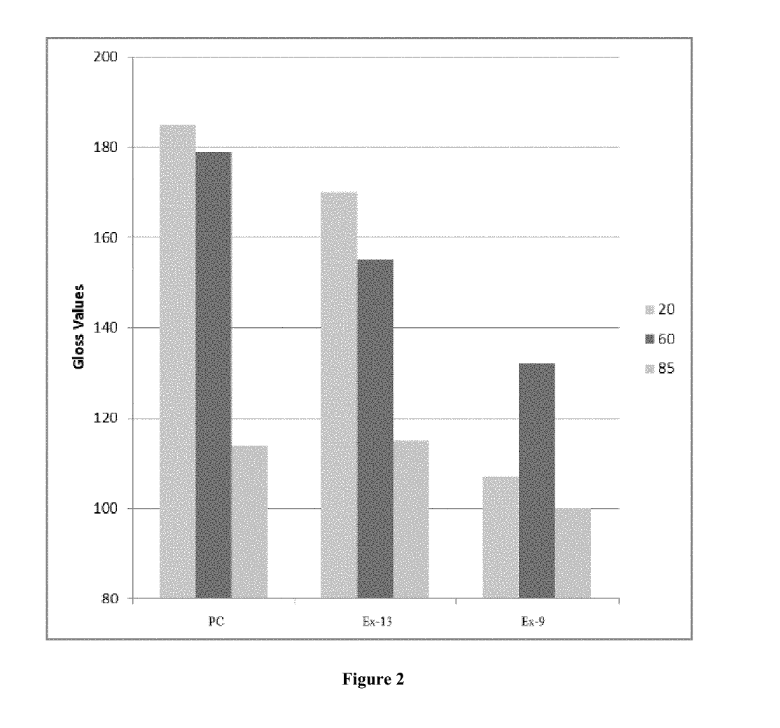

Tables 1-7 provide data for compositions of antifog compositions in accordance with aspects and embodiments of the present invention. Time to fog for the coatings was measured, and, as illustrated most of the coating showed antifog performance. Some of the coatings had some hazy spots after the antifog was measured from the dried water spots. Haze was measured after antifog property of coating was evaluated. FIG. 1 shows the comparison of haze before and after antifog measurement for Examples 9 and 13. If the coating were left on the bench in the ambient humid condition, some of the coating absorbed moisture from ambient and appeared slightly haze and less glossy. Haze values are compared and presented in FIG. 1(b). FIG. 2 shows the gloss of the coating for Examples 9 and 13 compared to a polycarbonate sheet without a coating. The higher the gloss unit (GU) value, the more glossy is the coating. The gloss values are measured at three different angles: 20°, 60°, and 85°. Measurement angle refers to the angle between the incident light and the perpendicular to the substrate. Three measurement angles (20°, 60°, and 85°) are generally specified to cover the majority of industrial coatings applications. Coating from Ex-13 shows gloss values closer to the polycarbonate than coating from Ex-9. Adhesion of coating was also evaluated while soaking the coated panels in water at 65° C. and some of the coating completely lost adhesion in lhr and some of the coating still maintained very good adhesion with substrate even after 5 days as presented in Table 8. As demonstrated in the examples in the various tables, compositions in accordance with the present technology are suitable for providing coatings that exhibit good properties including for example, antifog, optical, and adhesion properties.

While the invention has been described with reference to various exemplary embodiments, it will be appreciated that modifications may occur to those skilled in the art, and the present application is intended to cover such modifications and inventions as fall within the spirit of the invention.

What is claimed is:

1. A curable coating composition comprising:
(i) at least one acrylic functional silicone material;
(ii) at least one acrylic functional organic material; and
(iii) at least one acrylic functional urethane material.

2. The curable composition of claim 1, wherein the acrylic functional silicone material (i) is chosen from a silicone polyether acrylate, a silicone dimethacrylate, a silicone acrylamide, or a combination of two or more thereof.

3. The curable composition of claim 1, wherein the acrylic functional silicone material (i) is chosen from a compound of the formula: 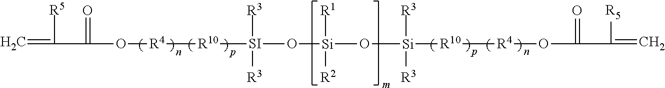
wherein R¹ and R² are independently chosen from a C1-C10 alkyl group, a C6-30 aryl group or R⁴; wherein each occurrence of R³ is independently chosen from a C1-C10 alkyl group or a C6-C30 aryl group; wherein each occurrence of R⁴ is independently a linear or a branched alkylene chain of 1 to 10 carbon atoms optionally substituted with at least one heteroatom chosen from O, N or S; wherein each occurrence of R⁵ is independently chosen from hydrogen or a C1-C6 alkyl group; R¹⁰ is polyether unit; m is an integer ≧0; n is an integer from 1 to 100, and p is an integer from 0 to 100.

4. The curable composition of claim 1, wherein the acrylic functional silicone material (i) is present in an amount of from about 2 wt. % to about 60 wt. % based on the weight of a dry film formed from the composition.

5. The curable composition of claim 1, wherein the acrylic functional organic material (ii) is chosen from a compound of the formula: 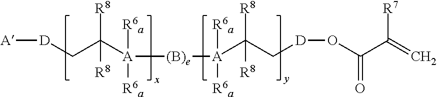
wherein
R⁶ is independently selected from the group consisting of: O; H; a linear alkyl group containing from 1 to 5 carbon atoms; a linear alkyl group containing from 1 to 5 carbon atoms substituted with a hydroxy or an alkoxy group; an aromatic group; a hydroxy group; an alkoxy group containing from 1 to 3 carbon atoms; a methacrylate; and an acrylate group; wherein a is 0 or 1;
R⁷ is independently chosen from H or CH₃;
R⁸ is independently selected from the group consisting of H, an alkyl group having from 1 to 6 carbon atoms, a hydroxy group, an alkoxy group having from 1 to 3 carbon atoms, a methacrylate group, and an acrylate group;
A is independently selected from the group consisting of O, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, an alkylene oxide, and a substituted or unsubstituted divalent heterocyclic group having from 5 to 20 carbon atoms;
A′ is independently selected from H, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, a substituted or unsubstituted divalent heterocyclic group having from 5 to 20 carbon atoms, a methacrylate group, and an acrylate group;
B is independently selected from O, an NH moiety, a substituted or unsubstituted linear alkyl group having from 1 to 20 carbon atoms, a substituted or unsubstituted cycloalkyl group having from 1 to 20 carbon atoms, a substituted or unsubstituted divalent aromatic group having from 6 to 20 carbon atoms, a substituted or unsubstituted divalent heterocyclic group having from 5 to 20 carbon atoms, and a bisphenol A unit; wherein e is an integer from 0 to 1;
D is independently selected from null, direct bond, a substituted or unsubstituted linear alkyl group having from 1 to 20 carbon atoms, isopropanol, epoxy ring opened unit, a substituted or unsubstituted divalent aromatic group having from 6 to 20 carbon atoms, a substituted or unsubstituted divalent heterocyclic group having from 5 to 20 carbon atoms; and
y is an integer from 1 to 50 and x is an integer from 0 to 50.

6. The curable composition of claim 1, wherein the acrylic functional organic material (ii) is chosen from a poly(ethyleneoxy)methacrylate, a poly(ethyleneoxy)acrylate, a poly(ethyleneoxy)monomethylether acrylate, a poly(ethyleneoxy)monomethylether methacrylate, a pentaerythritol triacrylate, a glycerol dimethacrylate, a glycerol diacrylate, a bisphenol-A-glycerol tetraacrylate, a bisphenol-A-glycerol diacrylate, a bisphenol-A-ethyleneoxy diacrylate, or a combination of two or more thereof.

7. The curable composition of claim 1, wherein the acrylic functional organic material (ii) is chosen from Isooctyl Acrylate; 2-2(Ethoxyethoxy)ethyl Acrylate; Isodecyl Acrylate; Isodecyl Methacrylate; Lauryl Acrylate; Lauryl Methacrylate; Isodecyl Acrylate; Propoxylated Neopentyl Glycol Diacrylate; Alkoxylated Difunctional Acrylate Ester; Glycidyl Methacrylate; Propoxylated Neopentyl Glycol Diacrylate; Alkoxylated Difunctional Acrylate Ester; Tridecyl Methacrylate; Tridecyl Acrylate; Caprolactone Acrylate; Tripropylene Glycol Diacrylate; Stearyl Methacrylate; Tris (2-Hydroxy Ethyl) isocyanurate Triacrylate; 1,3-Butylene Glycol Dimethacrylate; 1,3-Butylene Glycol Diacrylate; Neopentyl Glycol Diacrylate; Neopentyl Glycol Dimethacrylate; Ethylene Glycol Dimethacrylate; Alkoxylated Aliphatic Diacrylate Ester; 1,4-Butanediol Diacrylate; 1,4-Butanediol Dimethacrylate; C14-C15 Acrylate Terminated Monomer; Tetrahydrofurfuryl Methacrylate; Hexanediol Diacrylate; 1,6-Hexanediol Dimethacrylate; 1,6-Hexanediol Diacrylate; Tetrahydrofurfuryl Acrylate; Hexanediol Dimethacrylate; Propoxylated Trimethylolpropane Triacrylate; Cyclohexyl Acrylate; Highly Propoxylated Glyceryl Triacrylate; Tetrahydrofurfuryl Acrylate; Cyclohexyl Methacrylate; Triethylene Glycol Dimethacrylate; C14-C15 Methacrylate Terminated Monomer; Tetraethylene Glycol Dimethacrylate; Propoxylated₃ Trimethylolpropane Triacrylate; Diethylene Glycol Diacrylate; Polyethylene Glycol Dimethacrylate; Propoxylated Glyceryl Triacrylate; Triethylene Glycol Diacrylate; Diethylene Glycol Dimethacrylate; Highly Propoxylated Glyceryl Triacrylate; Tetraethylene Glycol Diacrylate; Caprolactone Acrylate; Polyethylene Glycol (200) Diacrylate; Polyethylene Glycol (400) Dimethacrylate; Di-trimethylolpropane Tetraacrylate; Polyethylene Glycol (600) Dimethacrylate; Polyethylene Glycol (400) Diacrylate; Polyethylene Glycol (600) Dimethacrylate; Polyethylene Glycol (600) Diacrylate; Ethoxylated Trimethylolpropane Triacrylate; Ethoxylated₃ Trimethyolopropane Triacrylate; Ethoxylated₆ Trimethylolpropane Triacrylate; Ethoxylated₉ Trimethylolpropane Triacrylate; Ethoxylated₁₅ Trimethylolpropane Triacrylate; Alkoxylate d Trifunctional Acrylate Ester; Ethoxylated Trimethylolpropane Triacrylate; Ethoxylated₂₀ Trimethylolpropane Triacrylate; Trimethylolpropane Trimethacrylate; Ethoxylated Trimethylolpropane Triacrylate; Ethoxylated Pentaerythritol Triacrylate; Isobornyl Acrylate; Trimethylolpropane Triacrylate; Trifunctional Methacrylate Ester; Trifunctional Methacrylate Ester; Trifunctional Methacrylate Ester; Isobornyl Acrylate; Isobornyl Methacrylate; Isobornyl Methacrylate; Di-Trimethylolpropane Tetraacrylate; Pentaerythritol Triacrylate; Aliphatic Urethane Acrylate; Low Viscosity Aliphatic Diacrylate; Pentaerythritol Tetraacrylate; Dipentaerythritol Pentaacrylate; Low Viscosity Aliphatic Triacrylate Oligomer; Dimethacrylate Aliphatic Urethane Acrylate; Ethoxylated Nonylphenol Acrylate; Phenoxyethyl Methacrylate; 2-Phenoxyethyl Methacrylate; Ethoxylated₁₀ Bisphenol A Diacrylate; Phenoxyethyl Acrylate; 2-Phenoxyethyl Acrylate; Ethoxylated₆ Bisphenol A Dimethacrylate; Ethoxylated₄ Bisphenol A Dimethacrylate; Ethoxylated₄ Bisphenol A Diacrylate; Ethoxylated Bisphenol A Dimethacrylate; Ethoxylated₂ Bisphenol A Dimethacrylate; Ethoxylated Bisphenol A Diacrylate, or a combination of two or more thereof.

8. The curable composition of claim 1, wherein the acrylic functional organic material (ii) is present in an amount of from about 1 wt. % to about 80 wt. % based on the weight of a dry film formed from the composition.

9. The curable composition of claim 1, wherein the acrylic functional urethane (iii) comprises two or more acrylate functional groups.

10. The curable composition of claim 1, wherein the acrylic functional urethane (iii) is chosen from an aliphatic polyester urethane acrylate, an aliphatic polyether urethane acrylate, an acrylated polyurethane dispersion, or a combination thereof.

11. The curable composition of claim 1, wherein the acrylic functional urethane (iii) is present in an amount of from about 5 wt. % to about 98 wt. % based on the weight of a dry film formed from the composition.

12. The curable composition of claim 1 further comprising metal oxide particles (iv) chosen from silica oxide particles, aluminum oxide particles, cerium oxide, titanium oxide, zinc oxide particles, tin oxide particles, or a combination of two or more thereof.

13. The curable composition of claim 1, wherein the metal oxide particles (iv) are functionalized with a silane and siloxane.

14. The curable composition of claim 1, wherein the metal oxide particles (iv) are present in an amount of from about 0.1 to about 40 wt. % based on the weight of a dry film formed from the composition.

15. The curable composition of claim 1 further comprising a photoinitiator, thermal initiator, surface active agent, cure promoters and mixtures thereof.

16. The curable composition of claim 1 further comprising at least one surfactant chosen from an ionic surfactant, a non-ionic surfactant, or a combination thereof.

17. An article comprising a substrate, wherein at least a portion of a surface of the substrate comprises a coating formed the curable composition of claim 1.

18. The article of claim 17, wherein the substrate is chosen from an acrylic polymer, a polyamide, a polyacrylate, a polyimide, an acrylonitrile-styrene copolymer, a styrene-acrylonitrile-butadiene terpolymer, a polyvinyl chloride, a polyethylene, a polycarbonate, or a combination thereof.

19. The article of claim 17, wherein the substrate comprises a polycarbonate.

20. The article of claim 17, wherein the coating has a transmittance of coating of at least 85%.

21. The article of claim 17, wherein the coating after curing has a transmittance of coating of at least 89%.

22. The article of claim 17, wherein the article is an automobile headlight, a windshield, eyeglasses, goggles, a mirror, a storage container, a window, or a camera lens.

23. A method of forming an article coated with an antifog coating comprising:
applying the curable composition of claim 1 to a surface of a substrate; and
exposing the curable composition to actinic or electron beam radiation to cure the coating.
